(19) United States
(12) Patent Application Publication
(10) Pub. No.: US 2007/0003330 A1
(43) Pub. Date: Jan. 4, 2007

(54) DEVELOPING ROLLER AND DEVELOPING CARTRIDGE HAVING THE SAME

(76) Inventor: Hyun-cheol Lee, Suwon-si (KR)

Correspondence Address: STANZIONE & KIM, LLP, 919 18TH STREET, N.W., SUITE 440, WASHINGTON, DC, 20006, US

(21) Appl. No.: 11/420,959

(22) Filed: May 30, 2006

(30) Foreign Application Priority Data
Jun. 29, 2005 (KR) 2005-56944

(51) Int. Cl. G03G 15/08

(52) U.S. Cl. 399/286

(57) ABSTRACT

A developing roller and a developing cartridge having the same include a conductive elastic body thicker at opposite ends of a developing roller shaft than at an axial center portion of the developing roller shaft such that print defects are prevented regardless of resilient deformation or thermal deformation of the conductive elastic body.

### CROSS-REFERENCE TO RELATED APPLICATIONS

This application claims the benefit under 35 U.S.C § 119 of Korean Patent Application No. 10-2005-56944, filed on Jun. 29, 2005, in the Korean Intellectual Property Office, the disclosure of which is incorporated herein in its entirety.

### BACKGROUND OF THE INVENTION

1. Field of the Invention

The present general inventive concept relates to a developing roller and a developing cartridge having the same, and more particularly, to a developing roller capable of preventing print defects and a developing cartridge having the same.

2. Description of the Related Art

An electrophotographic image forming apparatus, such as a printer, copier, multi-function device, and the like, is an apparatus that prints images on a print medium using an electrophotographic process. In the electrophotographic image forming apparatus, an electrostatic latent image is formed onto an outer circumference of a photosensitive body and then developed by a developing roller using a developer. A developing cartridge includes the developing roller and the developer and is detachably mounted to the body of the image forming apparatus. The photosensitive body is provided in the developing cartridge or directly fixed to the body of the image forming apparatus according to a type of the image forming apparatus.

A developing method can be generally classified into two methods based on whether the developing roller and the outer circumferential surface of the photosensitive body are in contact with each other. In the case in which the developing roller and the outer circumferential surface of the photosensitive body are in direct contact with each other, a developing nip is formed where a developing operation is performed. A size of the developing nip is a length in which the developing roller and the outer circumferential surface of the photosensitive body are in elastic contact with each other along a circumferential direction of the developing roller. In the case in which the developing roller and the outer circumferential surface of the photosensitive body are not in contact with each other, a developing gap is formed where a developing operation is performed. For an efficient developing operation, the developing gap or the developing nip should be uniformly maintained in an axial direction of the developing roller. For convenience, the case in which the developing operation is performed at the developing gap will now be explained.

FIG. 1 is a sectional view illustrating a conventional developing roller 10. Referring to FIG. 1, the developing roller has a developing roller shaft 11 and a conductive elastic body 12. The developing roller shaft 11 is a center of rotation of the developing roller 10. A circumference of the developing roller shaft 11 has the conductive elastic body 12 mounted thereto. The conductive elastic body 12 is a conductive material for applying a developing bias voltage, and is a resilient material that contacts a regulating member (not shown) regulating a thickness of the developer applied thereto, the photosensitive body 20 and a supply roller (not shown). Generally, the conductive elastic body 12 has a shape of a cylinder with a constant thickness in an axial direction, and the outer diameter of the developing roller 10 is constant in the axial direction.

FIG. 2 is a perspective view illustrating a contact state between a photosensitive body 20 and the conventional developing roller 10. Referring to FIG. 2, the developing roller 10, the photosensitive body 20, and a gap ring 13 are illustrated. The gap ring 13 is coupled to both ends of the developing roller 10 so as to allow the developing roller 10 and the photosensitive body 20 to maintain a constant developing gap therebetween without directly contacting each other. For convenience of description, FIG. 2 exaggerates the illustration of a state in which axial parallelism of the photosensitive body 20 and the developing roller 10 is distorted. That is, when the axial parallelism of the photosensitive body 20 and the developing roller 10 is distorted, the developing gap is not constant. An electrostatic attractive or repulsive force causes the developer to jump through the developing gap. Therefore, the size of the developing gap between the photosensitive body 20 and the developing roller 10 has an effect on a density of the developer developing the electrostatic latent image. The larger the developing gap is, the lower the density of the developer is. If the size of the developing gap is not uniform or deviates from an allowable range, the density of the developer forming the print image becomes inconsistent at right and left sides thereof, or a blank portion of the print image in which the print image is not printed is generated.

Since the photosensitive body 20 and the developing roller 10 essentially involve an assembly tolerance and a dynamic deformation upon rotation, they can not be completely parallel to each other in 3-dimensional space, but only become approximately parallel to each other within an allowable tolerance. As the photosensitive body 20 and the developing roller 10 deviate from the parallel state with respect to each other, the developing gap at the axial center portion of the developing roller 10 is geometrically gradually smaller than the developing gap at both ends thereof, so that the non-uniformity of the developing gap is increased. Typically, if the developing gap deviates from a predetermined level by 20 μm or more, the quality of print becomes degraded. Particularly, in halftone image printing, even if a print defect is generated in one print dot, the print defect influences the print quality for the entire image. For example, in the case of a black and white image forming apparatus, the image to be printed is resolved into many gray tones between white that is a basic color of the print medium and black that is a color of the developer. A process in which such gray tones are defined between white and black into for example, 256-level gradation, converted into a digital image, and then printed is called an image halftoning or image rendering. In halftoning image printing, the individual print defect generated at the respective dots has a large effect on the print quality for the entire image.

FIG. 3 illustrates a case in which the developing gap becomes non-uniform due to an elastic deformation of the conductive elastic body 12. In order to maintain a constant thickness of the developer attached to the circumference of the developing roller 10, the regulating member (not shown) is provided. With the contact force of the regulating member, the conductive elastic body 12 is resiliently deformed into a different shape from an initial shape thereof. This is because the conductive elastic body 12 is resiliently deformed in an opposite direction to the contact position at which the regulating member contacts the conductive elastic body 12. Particularly, FIG. 3 illustrates a case in which the developing gap Gc at the center portion of the developing roller 10 is smaller than the developing gap Gs at both ends of the developing roller 10 due to the elastic deformation of the conductive elastic body 12. As the thickness of the conductive elastic body 12 increases, the quantity of the elastic deformation increases. As a result, a print defect is generated, such as a non-uniform density of the developer between a center portion and both ends of a printed image.

### SUMMARY OF THE INVENTION

The present general inventive concept provides a developing roller capable of preventing a print defect, and a developing cartridge having the same.

Additional aspects and utilities of the present general inventive concept will be set forth in part in the description which follows and, in part, will be obvious from the description, or may be learned by practice of the general inventive concept.

The foregoing and/or other aspects of the present general inventive concept are achieved by providing a developing roller including a developing roller shaft that is a center of rotation, and a conductive elastic body coupled to a circumference of the developing roller shaft to form a developing gap or a developing nip with a photosensitive body which forms an electrostatic latent image thereon in an electrophotographic manner, and the conductive elastic body has a thickness thicker at opposite ends of the developing roller shaft than at an axial center portion of the developing roller shaft.

The conductive elastic body may have a shape of a cylinder in which a step portion is formed at an inner circumference.

The conductive elastic body may have a shape of a cylinder in which a taper portion is formed at an inner circumference.

The conductive elastic body may have a shape of a cylinder in which a curved gradient is formed at an inner circumference.

The outer diameter at opposite axial ends of the developing roller may be greater than or equal to the outer diameter at an axial center portion thereof.

The thickness of the conductive elastic body may be substantially 0.5 through 2.0 mm at the axial center portion of the developing roller shaft.

The foregoing and/or other aspects of the present general inventive concept are also achieved by providing a developing cartridge to store a developer, and the cartridge includes a developing roller, the developing roller including a developing roller shaft that is a center of rotation, and a conductive elastic body coupled to a circumference of the developing roller shaft to form a developing gap or a developing nip with a photosensitive body which forms an electrostatic latent image thereon in an electrophotographic manner, and the conductive elastic body has a thickness thicker at opposite ends of the developing roller shaft than at an axial center portion of the developing roller shaft.

The foregoing and/or other aspects of the present general inventive concept are also achieved by providing a developing roller usable with an electrophotographic image forming apparatus having a photosensitive body, including a rotatable developing roller shaft having a thickness greater at a center thereof than at opposite ends thereof, and a conductive elastic body coated on an outer circumference of the rotatable developing roller to form a developing gap or a developing nip with the photosensitive body.

The foregoing and/or other aspects of the present general inventive concept are also achieved by providing a developing cartridge usable with an electrophotographic image forming apparatus, including a storage unit to store a developer, and a developing roller to provide the developer to an electrostatic latent image on the electrophotographic image forming apparatus, including a rotatable shaft having a thickness greater at a center thereof than at opposite ends thereof, and a conductive elastic body coated on an outer surface of the rotatable shaft.

The foregoing and/or other aspects of the present general inventive concept are also achieved by providing an electrophotographic image forming apparatus, including a photosensitive body to form an electrostatic latent image thereon, and a developing roller to supply a developer to the photosensitive body, and including a rotatable shaft having a greater thickness at a center portion thereof than at axial end portions thereof and a conductive elastic body formed on an outer surface of the rotatable shaft to form a developing nip or a developing gap with the photosensitive body.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a sectional view illustrating a conventional developing roller;

FIG. 2 is a perspective view illustrating a contact state in which a photosensitive body and a conventional developing roller are in contact with each other;

FIG. 3 is a sectional view illustrating a developing gap of a photosensitive body and a conventional developing roller;

FIGS. 4 and 5 are side sectional views illustrating an image forming apparatus having a developing cartridge according to an embodiment of the present general inventive concept;

FIG. 6 is a view illustrating an exposure state of a photosensitive body of the image forming apparatus of FIGS. 4 and 5;

FIG. 7 is a graph illustrating a voltage difference of an electrostatic latent image between a center portion and opposite ends;

FIG. 8 is a graph illustrating an electrification bias voltage, a developing bias voltage, and a voltage of an electrostatic latent image; and

FIGS. 9 through 11 are sectional views illustrating a developing roller according to various embodiments of the present general inventive concept.

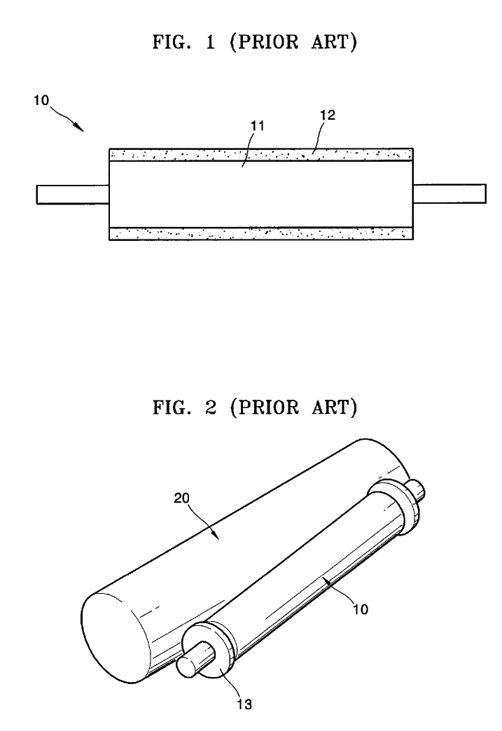

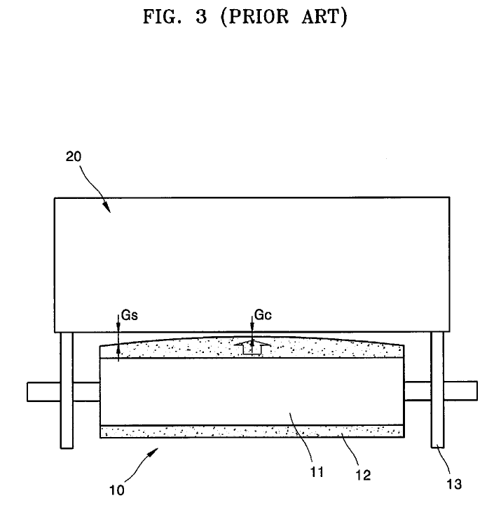

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

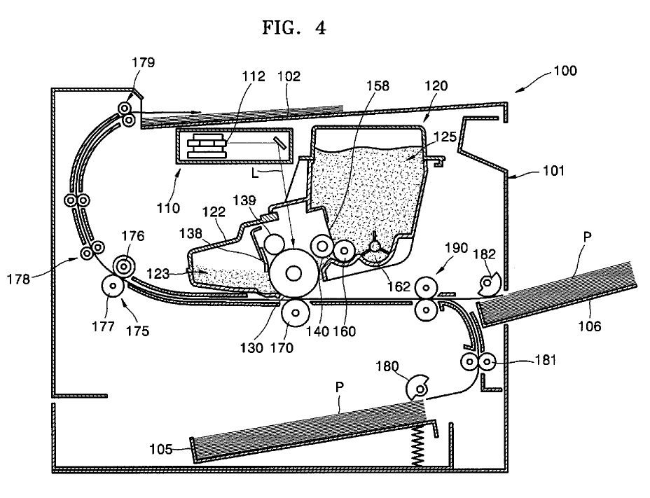

FIG. 4 is a side sectional view illustrating an electrophotographic image forming apparatus 100 according to an embodiment of the present general inventive concept. The image forming apparatus 100 includes a body 101, a photo scanning unit 110, a developing cartridge 120, a fuser 175, and a decurl unit 178.

The photo scanning unit 110 scans light L corresponding to image information onto a photosensitive body 130 to form an electrostatic latent image on an outer circumferential surface of the photosensitive body 130.

The developing cartridge 120 is detachably mounted in the body 101 of the image forming apparatus 100. As illustrated in FIG. 4, the developing cartridge 120 includes a developing roller 140 and the photosensitive body 130 facing the developing roller 140. A developing cartridge housing 122 forms an enclosure of the developing cartridge 120. In the developing cartridge housing 122, the photosensitive body 130, an electrification roller 139, a cleaning member 138, the developing roller 140, a regulating member 158, a supply roller 160 and an agitator 162 are provided. The developing cartridge 120 can be exchanged with a new one when developer stored in a storing unit 125 is completely exhausted.

The photosensitive body 130 can be mounted such that a portion of the outer circumference of the photosensitive body 130 is exposed through the developing cartridge housing 122 and such that the photosensitive body 130 rotates in a predetermined direction. A photoconductive material layer is coated on the outer circumferential surface of the photosensitive body by deposition or the like. The photosensitive body may be a cylindrical drum. The photosensitive body 130 is charged to a certain electric potential by the electrification roller 139, and the electrostatic latent image corresponding to the image information is formed on the outer circumferential surface of the photosensitive body by the light L irradiated from the photo scanning unit 110.

The developer may be in a solid powder phase. The developing roller applies the developer onto the electrostatic latent image formed on the photosensitive body 130 to develop the electrostatic latent image into a toner image. A developing bias voltage is applied to the developing roller 140 so as to apply the developer to the electrostatic latent image formed on the photosensitive body 130.

The supply roller 160 supplies the developer from the storing unit 125 to the developing roller 140. The agitator 162 agitates the developer in the storing unit 125 so as to prevent the developer from being solidified, and urges the developer toward the supply roller 160. The regulating member 158 contacts an outer circumferential surface of the developing roller 140 to regulate a thickness of the developer applied to the outer circumferential surface of the developing roller 140 and to frictionally charge the developer.

The cleaning member 138 is mounted to the developing cartridge housing 122 such that one end of the cleaning member 138 contacts the photosensitive body 130 with a predetermined pressure to scrape off the developer remaining on the photosensitive body 130 after the toner image is transferred to a print medium P.

A transfer roller 170 faces the outer circumferential surface of the photosensitive body 130. A transfer bias voltage having a polarity opposite to the toner image is applied to the transfer roller 170 so as to allow the toner image of the photosensitive body 130 to be transferred to the print medium P, which passes between the photosensitive body 130 and the transfer roller 170. Accordingly, the toner image is transferred to the print medium P by an electrostatic attractive force between the transfer roller 170 and the toner image and a mechanical contact pressure between the photosensitive body 130 and the transfer roller 170.

The fuser 175 includes a heating roller 176 and a pressing roller 177 mounted opposite to the heating roller and to respectively exert heat and pressure to fuse the transferred image to the print medium P.

The decurl unit 178 removes a curl of the print medium P generated by the heat of the fuser 175. A delivery roller 179 discharges the print medium P from the image forming apparatus 100. The print medium P discharged from the image forming apparatus 100 is stacked on a delivery tray 102.

A delivery path of the print medium P is as follows. The image forming apparatus 100 includes first and second paper feed cassettes 105 and 106 in which the print medium P is stacked. Pick-up rollers 180 and 182 pick up and draw the stacked print medium P one sheet at a time. A carrying roller 181 provides a carrying force to carry the picked-up print medium P from the first paper feed cassette 105 toward a paper aligning section 190. The paper aligning section 190 aligns the print medium P before the print medium P passes between the photosensitive body 130 and the transfer roller 170 such that the toner image is transferred to a desired portion of the print medium P.

In the developing cartridge housing 122, a waste storage unit 123 is provided to store waste developer removed from the photosensitive body 130 by the cleaning member 138, and the storage unit 125 is provided to store the developer to be supplied to the developing roller 140 by the supply roller 160.

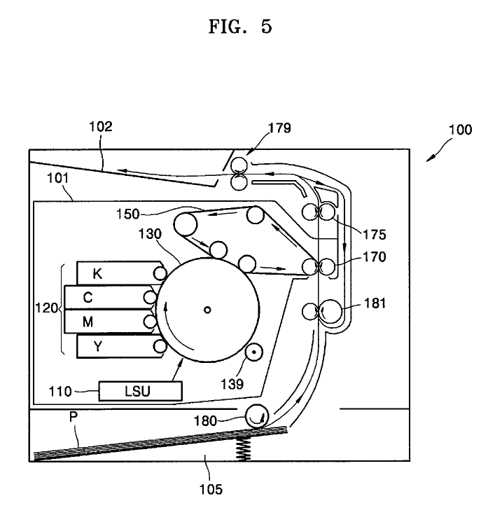

Although the embodiment of the developing cartridge 120 and the electrophotographic image forming apparatus 100 as illustrated in FIG. 4 are usable for monochromatic printing, the present general inventive concept is not limited thereto. FIG. 5 illustrates an embodiment of the developing cartridge 120 and the electrophotographic image forming apparatus 100 usable for color printing. Since like numeral refers to like elements, same description will be omitted. For color printing in electrophotographic method, a plurality of developing cartridges 120 are required.

Referring to FIG. 5, the multi-pass type image forming apparatus 100 includes the photosensitive body 130 and four developing cartridges 120. For example, the four developing cartridges 120 can contain developers of cyan C, magenta M, yellow Y, and black K colors, respectively. If a toner image of for example, the yellow color is completely transferred to the transfer belt 150 by the above described method, the toner images of the magenta M, cyan C and black K colors are then sequentially transferred to the transfer belt 150 to overlap with one another. Accordingly, a complete color toner image is transferred to the transfer belt 150. The toner image transferred to the transfer belt 150 is then transferred to the print medium P by the transfer roller 170.

Although not illustrated, a single-pass type image forming apparatus includes four developing cartridges and four photosensitive bodies, and a 2-pass type image forming apparatus includes two units each having two developing cartridges and one photosensitive body.

In the various embodiments of the monochromatic or color image forming apparatus 100, the photosensitive body 130 can be mounted in the developing cartridge 120 or the body 101 of the image forming apparatus. The outer circumferential surfaces of the developing roller 140 and the photosensitive body 130 may contact each other to form a developing nip, or the outer circumferential surfaces may be spaced apart from each other to form a developing gap. If possible, the developing nip or the developing gap should be uniformly maintained at a constant size along the axial directions of the developing roller 140 and the photosensitive body 130 during operation of the image forming apparatus 100. It is important to maintain the developing nip or gap as uniform as possible, as the number of photosensitive bodies 130, developing rollers 140, or developing cartridges 120 increase. As described below, a conductive elastic body (142a, 142b, and 142c) and/or a developing roller shaft (141a, 141b, and 141c) can be made to have a non-uniform thickness and/or a non-uniform diameter, respectively, to minimize any change in the developing gap or nip that occurs during operation of the image forming apparatus 100.

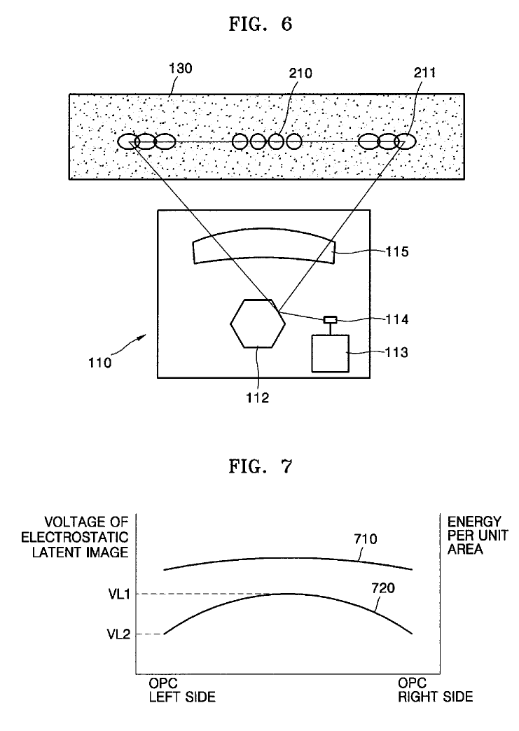

FIG. 6 is a view illustrating a photo scanning procedure. Referring to FIG. 6, the photo scanning unit 110 includes a light source 113 to generate light, a light directing section 114 to direct the light generated by the light source 113, a beam deflector 112 to deflect the light directed by the light directing section 114, and a lens section 115 to scan the light deflected by the beam deflector 112 to the photosensitive body 130. For example, a unit light of 1 dot scanned to the photosensitive body 130 becomes a circle 210 at a center portion of the photosensitive body 130 and an ellipse 211 at opposite ends of the photosensitive body 130.

FIG. 7 is a graph illustrating voltages VL1 and VL2 of an electrostatic latent image and energy per unit area of the light scanned to the photosensitive body 130. The transverse axis indicates the axial direction of the photosensitive body 130. The left axis of ordinate indicates the voltage of the electrostatic latent image denoted as 720, and the right axis of ordinate indicates light energy per unit area denoted as 710. Compared with the light at the center portion of the photosensitive body 130 having the circular shape denoted as 210 in FIG. 6, the light at the opposite ends of the photosensitive body 130 having the ellipse shape denoted as 211 in FIG. 6 has lower energy per unit area. The outer circumferential surface of the photosensitive body 130 is charged at a constant electric potential by the electrification roller 139 to which an electrification bias voltage is applied. For example, the outer circumferential surface of the photosensitive body 130 can be charged by the electrification bias voltage of approximately (−)700V through (−)800V. An inner circumference of the photosensitive body 130 is grounded. When the charged outer circumferential surface of the photosensitive body 130 is scanned with the light, a resistance thereof is locally lowered, charges pass through the ground, and the electrostatic latent image is thus formed. For example, voltages VL1 and VL2 of the electrostatic latent image can be approximately (−)50V through (−)150V. Since the light energy per unit area decreases toward the opposite ends of the photosensitive body 130, an amount of resistance of the photosensitive body 130 also decreases. Accordingly, the voltage VL1 of electrostatic latent image at the center portion of the photosensitive body 130 is higher than the voltage VL2 of the electrostatic latent image at the opposite ends of the photosensitive body 130.

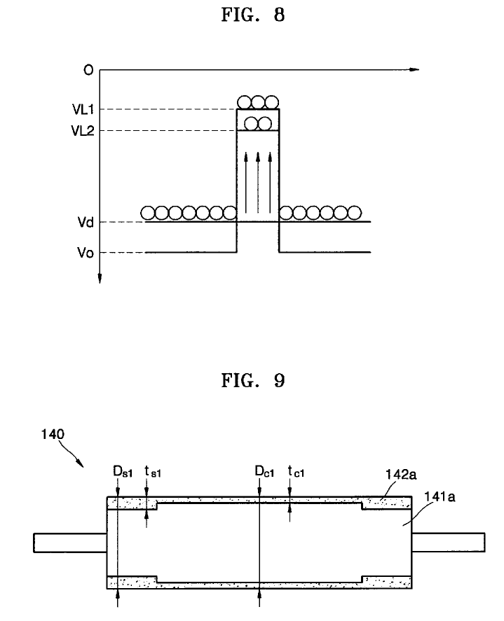

FIG. 8 is a graph illustrating the electrification bias voltage V0, the developing bias voltage Vd and the voltages VL1 and VL2 of electrostatic latent image. The transverse axis indicates the axial direction of the photosensitive body 130, and the axis of ordinate indicates voltage. The electrification bias voltage V0, the developing bias voltage Vd, and the voltages VL1 and VL2 of electrostatic latent image are set to various values based on a size of the developing gap (or the developing nip) and a print condition of the image forming apparatus. For example, if the electrification bias voltage V0 is approximately (−)700V through (−)800V and the voltages VL1 and VL2 of electrostatic latent image are approximately (−)50V through (−)150V, as described above, the developing bias voltage Vd applied to the outer circumferential surface of the developing roller 140 can be approximately (−)350V through (−)450V. The circumferential surface of the photosensitive body 130 can be defined into a non-exposure portion and an exposure portion of the electrostatic latent image. Voltage of the non-exposure portion is approximately equal to the electrification bias voltage V0, and the exposure portion of electrostatic latent image is equal to VL1 at the center portion and to VL2 at the opposite ends.

When the light is scanned to the photosensitive body 130 as illustrated in FIG. 6, since the voltage difference between the voltage VL1 of the electrostatic latent image and the developing bias voltage Vd at the center portion of the photosensitive body 130 is greater than the voltage difference between the voltage of the electrostatic latent image VL2 and the developing bias voltage Vd at the opposite ends of the photosensitive body 130, a density of the applied developer is greater at the center portion than at the opposite ends. Furthermore, the density increases as the size of the developing gap decreases. If the size of the developing gap becomes greater at the center portion of the photosensitive body 130 than at the opposite ends thereof, the developing density can be uniformly maintained along the axial direction. Thus, according to an embodiment of the present general inventive concept, the developing roller 140 is formed such that the outer diameter of opposite axial ends of the developing roller 140 is greater than or equal to the diameter of a center portion of the developing roller 140.

FIGS. 9 through 11 are sectional views illustrating the developing roller 140 according to various embodiments of the present general inventive concept.

Referring FIGS. 9 through 11, the developing roller 140 includes a developing roller shaft 141a, 141b, or 141c that is a center of rotation, and a conductive elastic body 142a, 142b or 142c coupled to the outer circumference of the developing roller shaft 141a, 141b or 141c. The developing roller shaft 141a, 141b or 141c can be provided by electroless plating of Ni onto stainless steel. The conductive elastic body 142a, 142b or 142c can be composed of silicon rubber, NBR rubber, or urethane rubber and the like, and coupled onto the outer circumferential surface of the developing roller shaft 141a, 141b or 141c with a single-material and single-layer structure or a heterogeneous materials and multi-layer structure.

The conductive elastic body 142a, 142b or 142c is resiliently deformed by the contact of the regulating member 158 as described above, and thermally expanded by material features, temperature, humidity, and the like. If the conductive elastic body 142a, 142b or 142c expands, the developing gap decreases. If a thickness of the conductive elastic body 142a, 142b or 142c increases, the developing gap is decreases even more because the amount of expansion is accumulated. A following table shows measuring results of the amount of expansion of the conductive elastic body 142a, 142b or 142c according to temperature, time, and humidity.

TABLE 1

| | Amount of expansion (μm) by | | | |
|---|---|---|---|---|
| Thickness of | temperature/time/humidity | | | |
| conductive | | 50° C./ | | |
| elastic | 50° C./ | 8 hours/80% | 50° C./ | 50° C./ |
| body (mm) | 2 hours | RH | 10 hours | 17 hours |
| 6.0 t | 33 | 43 | 50 | 87 |
| 2.5 t | 31 | 41 | 45 | 53 |
| 1.0 t | 7 | 9 | 9 | 9 |

Since the amount of elastic deformation by contact of the regulating member 158 or supply roller 160 increases as the thickness of the conductive elastic body 142a, 142b or 142c increases, the shape distortion of the conductive elastic body 142a, 142b or 142c is greater, and the thermal expansion or thermal shrinkage according to use time and temperature change in the image forming apparatus is accumulated. In the case of a conventional conductive elastic body having a uniform axial thickness, the resilient deformation tends to further accumulate at a center portion as compared to both axial ends. Also, the amount of thermal deformation tends to accumulate at the center portion because heat energy can be easily preserved at the center portion. The developing nip or gap is apt to be further reduced at the center portion as compared to both axial ends, so that the developing nip or gap becomes non-uniform in size along an axial direction. In the present embodiments of the general inventive concept, the thickness of the conductive elastic body 142a, 142b or 142c is varied along the axial direction. That is, the conductive elastic body 142a, 142b or 142c can have a thickness thicker at the opposite ends than at the center portion.

Furthermore, at an initial state before the resilient deformation or thermal deformation, the developing nip or gap can have a thickness thicker at the center portion than at the opposite ends. As illustrated in FIGS. 9 through 11, the developing roller 140 can be formed such that an outer diameter Ds1, Ds2 or Ds3 of the opposite ends thereof is greater than or equal to an outer diameter Dc1, Dc2 or Dc3 of the center portion thereof.

If the thickness of the conductive elastic body 142a, 142b or 142c is too thin, a hardness of the conductive elastic body 142a, 142b or 142c formed the outer circumferential surface of the developing roller shaft 141a, 141b or 141c increases, a frictional charging characteristic of the developer by the contact of the regulating member 158 becomes non-uniform, and a stress exerted to the developer increases. As a result, time dependant changes of print quality are generated, the developer is applied to a background area that is not a correct area to apply the developer, or print defect, such as forming a print missing dots at the opposite ends where a relatively small voltage difference between VL2 and Vd is provided. For example, the thickness tc1, tc2 or tc3 of the conductive elastic body 142a, 142b or 142c at the center portion of the developing roller 140 can be substantially 0.5 to 2.0 mm.

As described above, the thickness tc1, tc2 or tc3 of the conductive elastic body 142a, 142b, or 142c at the center portion of the developing roller 140 is thinner than the thickness ts1, ts2 or ts3 of the conductive elastic body 142a, 142b , or 142c at the opposite ends of the developing roller 140.

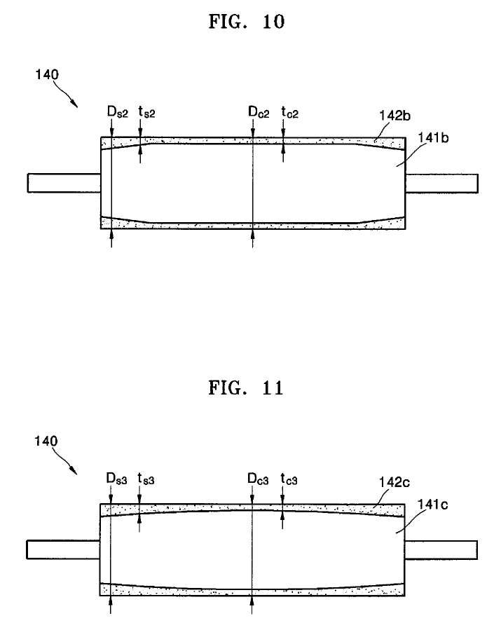

According to the various embodiments illustrated in FIGS. 9 through 11, the outer circumference of the developing roller shaft 141a, 141b or 141c and an inner circumference of the conductive elastic body 142a, 142b or 142c can have a step portion, taper portion, and curved gradient, respectively. That is, the conductive elastic body 142a, 142b or 142c can have a shape of cylinder with the step portion (see FIG. 9), the taper portion (see FIG. 10), or the curved gradient (see FIG. 11) formed at the inner circumference thereof. In addition, the developing roller shaft 141a, 141b or 141c can have a preferable shape of a cylinder with the step portion (see FIG. 9), the taper portion (see FIG. 10), or the curved gradient (see FIG. 11) formed at the outer circumference thereof. Further, the developing cartridge 120 according to various embodiments of the present general inventive concept can include the various embodiments of the developing roller 140, as described above.

Accordingly, print defects that would result from an elastic deformation of the conductive elastic body (e.g., 142a, 142b, or 142c) or a difference in energy per unit area of the light scanned to the photosensitive body 130, can be prevented by (1) making a magnitude of a center portion of a developing nip or gap greater than or equal to an end portion of the developing nip or gap, (2) making a thickness of the conductive elastic body at a center portion of the developing roller less than a thickness of the conductive elastic body at an end portion of the developing roller, or (3) making an outer diameter of a roller shaft (e.g., 141a, 141b, or 141c) of the developing roller greater at a center portion than at an end portion.

As described above, a developing roller and a developing cartridge having the same according to the embodiments of the present general inventive concept include a conductive elastic body thicker at opposite ends of the developing roller than at an axial center portion of the developing roller such that print defects are prevented regardless of resilient deformation or thermal deformation of the conductive elastic body.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A developing roller comprising:
a developing roller shaft that is a center of rotation; and
a conductive elastic body coupled to an outer circumference of the developing roller shaft and to form a developing gap or a developing nip with a photosensitive body which forms an electrostatic latent image thereon in an electrophotographic manner,
wherein the conductive elastic body has a thickness thicker at opposite ends of the developing roller shaft than at an axial center portion of the developing roller shaft.

2. The developing roller according to claim 1, wherein the conductive elastic body has a shape of a cylinder having a step portion formed at an inner circumference thereof.

3. The developing roller according to claim 1, wherein the conductive elastic body has a shape of a cylinder having a taper portion formed at an inner circumference thereof.

4. The developing roller according to claim 1, wherein the conductive elastic body has a shape of a cylinder having a curved gradient formed at an inner circumference thereof.

5. The developing roller according to claim 1, wherein an outer diameter at both opposite axial ends thereof is greater than or equal to that of an axial center portion thereof.

6. The developing roller according to claim 1, wherein the thickness of the conductive elastic body is substantially 0.5 through 2.0 mm at the axial center portion of the developing roller shaft.

7. A developing cartridge to store a developer, the developing cartridge comprising:
a developing roller including a developing roller shaft that is a center of rotation; and
a conductive elastic body coupled to an outer circumference of the developing roller shaft and to form a developing gap or a developing nip with a photosensitive body which forms an electrostatic latent image in an electrophotographic manner,
wherein the conductive elastic body has a thickness thicker at opposite ends of the developing roller shaft than at an axial center portion of the developing roller shaft.

8. The developing cartridge according to claim 7, wherein an outer diameter of opposite axial ends of the developing roller is greater than or equal to that of an axial center portion of the developing roller.

9. The developing cartridge according to claim 7, wherein the thickness of the conductive elastic body is substantially 0.5 through 2.0 mm at the axial center portion of the developing shaft.

10. A developing roller usable with an electrophotographic image forming apparatus having a photosensitive body, comprising:
a rotatable developing roller shaft having a thickness greater at a center thereof than at opposite ends thereof; and
a conductive elastic body coated on an outer circumference of the rotatable developing roller to form a developing gap or a developing nip with the photosensitive body.

11. The developing roller according to claim 10, wherein the developing roller shaft comprises:
a center portion having a first thickness; and
step portions each having a second thickness less than the first thickness and disposed at the opposite ends of the developing roller shaft.

12. The developing roller according to claim 10, wherein the developing roller shaft comprises:
a center portion; and
slope portions to slope from the center portion to the opposite ends of the developing roller shaft to linearly decrease the thickness of the developing roller shaft between the center portion and the opposite ends thereof.

13. The developing roller according to claim 10, wherein the developing roller shaft comprises a curved outer surface such that the developing roller shaft has a maximum thickness at the center thereof and a minimum thickness at the opposite ends thereof.

14. The developing roller according to claim 10, wherein the conductive elastic body is thicker at the opposite ends of the developing roller shaft than at the center of the developing roller shaft such that a thickness of the developing roller at opposite ends thereof is greater than or equal to the thickness of the developing roller at a center thereof.

15. A developing cartridge usable with an electrophotographic image forming apparatus, comprising:
a storage unit to store a developer; and
a developing roller to provide the developer to an electrostatic latent image on the electrophotographic image forming apparatus, comprising a rotatable shaft having a thickness greater at a center thereof than at opposite ends thereof, and a conductive elastic body coated on an outer surface of the rotatable shaft.

16. An electrophotographic image forming apparatus, comprising:
a photosensitive body to form an electrostatic latent image thereon; and
a developing roller to supply a developer to the photosensitive body, and including a rotatable shaft having a greater thickness at a center portion thereof than at axial end portions thereof and a conductive elastic body formed on an outer surface of the rotatable shaft to form a developing nip or a developing gap with the photosensitive body.
